(19) United States
(12) Patent Application Publication
(10) Pub. No.: US 2012/0048616 A1
(43) Pub. Date: Mar. 1, 2012

(54) GROMMET ASSEMBLY

(75) Inventor: Dennis M. Breen, IV, West Chicago, IL (US)

(73) Assignee: IDEAL Industries, Inc., Sycamore, IL (US)

(21) Appl. No.: 13/214,663

(22) Filed: Aug. 22, 2011

Related U.S. Application Data
(60) Provisional application No. 61/376,741, filed on Aug. 25, 2010.

(51) Int. Cl. H02G 3/00

(52) U.S. Cl. 174/651

(57) ABSTRACT

A grommet assembly for holding, sealing and/or protecting one or more wires of a wire harness as they pass through an opening in a panel. The grommet assembly includes a first grommet portion and a second grommet portion, each grommet portion having one or more wire receiving grooves with each wire receiving groove including a cylindrical-shaped slot that engages more than 180 degrees of the circumference of a wire, which enables the retention of a wire during assembly. The one or more wire receiving grooves include at least one compressible sealing rib for sealing around a wire. At least one of the wire receiving grooves may include a removable plug for sealing the wire receiving groove when a wire is not present.

### CROSS-REFERENCE TO RELATED APPLICATION

This application claims the benefit of U.S. Provisional Patent Application Ser. No. 61/376,741, filed Aug. 25, 2010, the disclosure of which is hereby incorporated by reference in its entirety.

### BACKGROUND

This disclosure relates to a grommet assembly for use with a wiring harness passing through an opening in a panel, such as is used to partition two adjacent, enclosed compartments, for example, the combustion chamber and blower chamber of a heating, ventilation, and air conditioning (HVAC) system.

A wire harness is commonly formed by bundling a plurality of electrical wires together prior to installation into the HVAC system. The wires often have electrical connectors at their ends. A wire harness connects one or more electrical components within an HVAC system and therefore must be routed through various air handling partitions. An air seal often is required between a panel or partition and the harness to maintain the pressure differential between various air handling compartments. It is desirable to provide support for the harness relative to the panel through which it passes to prevent abrasion with any sharp edges of the panel. Thus, it is commonly known to provide a grommet to protect and seal a harness where it passes through an opening in a panel.

Conventional grommets are formed of an elastic rubber to seal a harness to the panel opening. The rubber grommets are commonly installed by forcibly stretching the grommet to thereby allow axial insertion of the harness wires and any electrical connectors at the ends of the harness wires. When released, the rubber grommet attempts to conform to the harness which is located within an opening in the compartment panel. However the stretching and locating operations can distort the grommet preventing it from forming a complete seal around each wire.

Other known grommets are split into halves allowing for the grommet to be installed mid-harness, thus preventing the need to feed the harness thru the grommet axially. A split grommet has the disadvantage of not being able to retain the wires during assembly. The wire retention only occurs when the halves are finally joined together in compression around the harness, as the grommet is forced into an opening. This assembly process also includes holding the wires in place while trying to place the grommet halves around the harness, which can require substantial effort.

Some split grommets are configured to retain and seal around only a specific number of wires in a harness or a specific size of wire. This has the disadvantage of not allowing the manufacturer to use the same grommet in several different wiring harness configurations. As such it requires the manufacturer to create grommets of many different sizes for each wiring harness and opening configuration.

While discussed with respect to examples involving HVAC systems, it will be appreciated that the disclosed grommet assembly could be incorporated into other electrical apparatus and systems. Accordingly, while the present disclosure shows and demonstrates various example components, the examples are merely illustrative and are not to be considered limiting. It will be apparent to those of ordinary skill in the art that various grommets, electrical apparatus and systems can be constructed without departing from the scope or spirit of the present disclosure. Thus, although certain examples have been described herein, the scope of coverage of this patent is not limited thereto.

### SUMMARY

The present invention provides an improved device for holding, sealing, and protecting one or more wires of a wire harness as they pass through an opening in a panel. The grommet assembly of the present invention is comprised of two grommet portions that each retain one or more wires in wire receiving grooves. Each wire receiving groove is comprised of a cylindrical-shaped slot that engages more than 180 degrees of the circumference of a wire, and generally up to 270 degrees of the circumference. This engagement of a relatively significant cylindrical portion of each wire retains each wire within a grommet portion during the assembly of additional wires and when the grommet portions are assembled to each other. The wire receiving grooves also contain sealing ribs that compress around each installed wire. When the grommet portions are easily assembled to each other, the remaining unsealed area of the circumference of each wire is engaged by the raised partition between the wire receiving grooves of the opposing grommet portion. The grommet assembly is then installed into the panel with a simple rotation or twist to lock it in place.

There are instances where an HVAC system has been manufactured and installed in a building and then the owner decides to add additional features or functions to the system. The present invention will allow for additional wires to be installed into a grommet assembly and reengagement of the seal between the system compartments once the upgrade has been completed. Also, one or more of the wire receiving grooves may contain a removable plug. The removable plug may be located at or near the center of the wire receiving groove or may be located at or near an end of the wire receiving groove. The plug will seal a wire receiving groove if the plug has not been removed in favor of installing a wire. This allows for the grommet assembly initially to be installed into an opening in a panel with less than the maximum number of wires installed into the grommet assembly, while still providing a viable seal. Then, at a later time, the removable plug or plugs may be removed and additional wires may be installed in the now available wire receiving grooves.

An advantage of the grommet assembly of the present disclosure is that it provides a method for retaining wires individually in each grommet portion during installation of the grommet assembly to a wire harness.

Another advantage of the grommet assembly of the present disclosure is that it provides a method of sealing around each individual wire of a wire harness.

Another advantage of the grommet assembly of the present disclosure is that it provides a method of sealing around wires of varying diameter.

Another advantage of the grommet assembly of the present disclosure is that it provides a simple and effective method of expanding the number of wires contained within a grommet assembly, while being able to reestablish a seal at an opening between compartments.

Other objects, advantages and salient features of the disclosure will become apparent from the following detailed description, which is accompanied by the annexed drawings.

### BRIEF DESCRIPTION OF THE DRAWINGS

FIG. 1 is a perspective view of a first example grommet assembly in an installed position.

FIG. 2 is a perspective view of the grommet assembly of FIG. 1 in a removed position.

FIG. 3 is a perspective view of the grommet assembly of FIG. 1 with the grommet portions separated.

FIG. 4 is a perspective view of a first grommet portion of a grommet assembly and showing uninstalled wires.

FIG. 5 is an end view of the grommet assembly of FIG. 1, installed on wires of a wire harness.

FIG. 6A is a perspective sectional view A-A of the grommet assembly shown in FIG. 5.

FIG. 6B is a detail view from the perspective sectional view A-A of FIG. 6A.

FIG. 7 is an end view of the grommet assembly of FIG. 1, installed on wires of a wire harness.

FIG. 8A is a perspective sectional view B-B of the grommet assembly shown in FIG. 7.

FIG. 8B is a detail view from the perspective sectional view B-B of FIG. 8A.

FIG. 9 is an end view of the first grommet portion of FIG. 4.

FIG. 10A is a sectional view C-C of the first grommet portion shown in FIG. 9.

FIG. 10B is a detail view from the sectional view C-C of FIG. 10A.

FIG. 11 is a top view of the grommet assembly of FIG. 1, installed on wires of a wire harness.

FIG. 12A is a sectional view D-D of the grommet assembly shown in FIG. 11.

FIG. 12B is a detail view from the sectional view D-D of FIG. 12A.

FIG. 13 is a perspective view of a second example grommet assembly, installed on wires of a wire harness.

FIG. 14 is a perspective view of the grommet assembly of FIG. 13 shown in an unfolded position while installed on wires of a wire harness.

### DETAILED DESCRIPTION

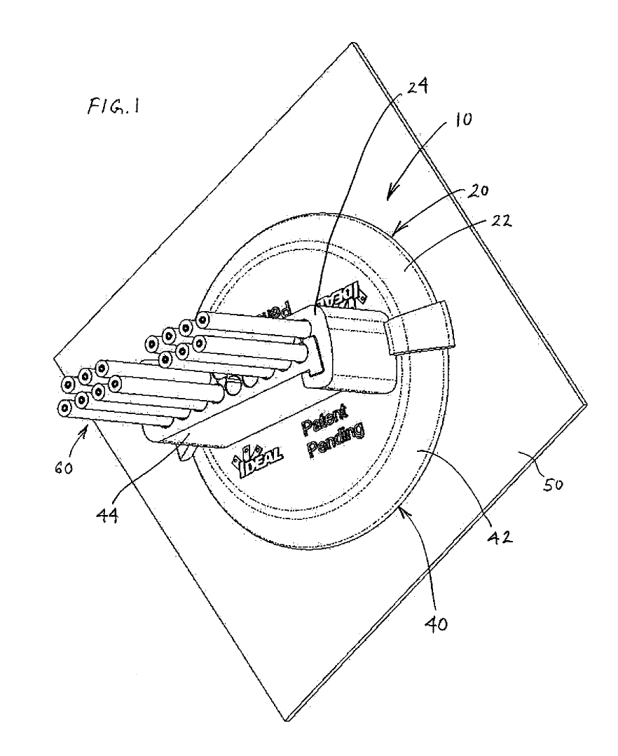

A first example grommet assembly is illustrated in FIGS. 1-12B. In FIG. 1 the grommet assembly 10 includes a first grommet portion 20 and second grommet portion 40. The grommet portions 20, 40 are made of a flexible resilient material such as EPDM rubber, or other suitable materials. Each grommet portion includes a semi-panel seal 22, 42, a wire pass thru section 24, 44, and a locking slot 26, 46, respectively. The grommet assembly 10 is installed into a partition or panel 50 through an opening 52. Formed within the opening 52 are panel locking tabs 54, 56.

A wire harness 60 is contained by the grommet assembly 10. In FIG. 2, the grommet assembly 10 is removed from the opening 52 in the panel 50. To install the grommet assembly into the panel 50, the grommet assembly 10 is moved into position within the opening 52 in the panel until the panel locking tabs 54, 56 engage the locking slots 26, 46 on the grommet assembly 10 by inserting the grommet assembly 10 into the panel opening 52 and rotating the grommet assembly 10 relative to the partition panel 50. This forces the panel locking tabs 54, 56 to come to rest in the locking slots 26, 46 of the grommet assembly 10.

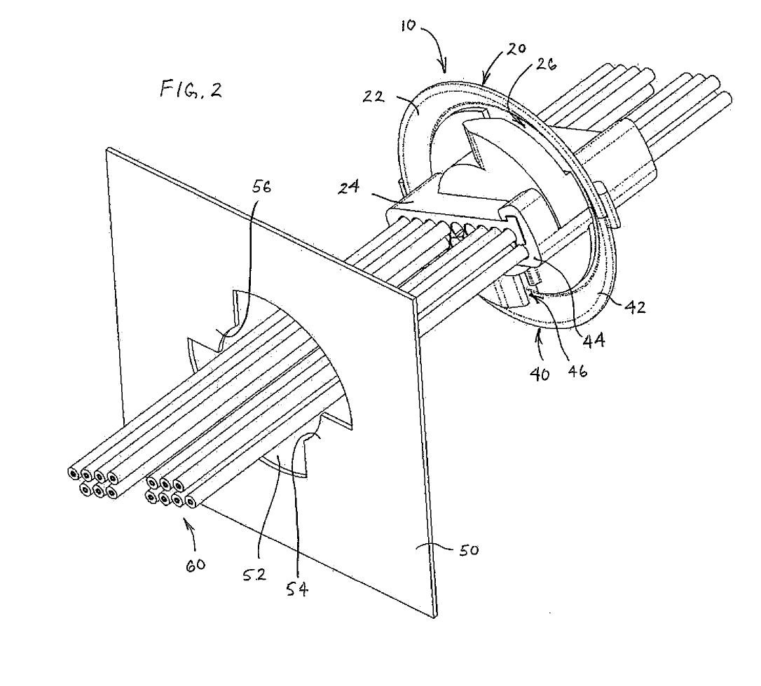

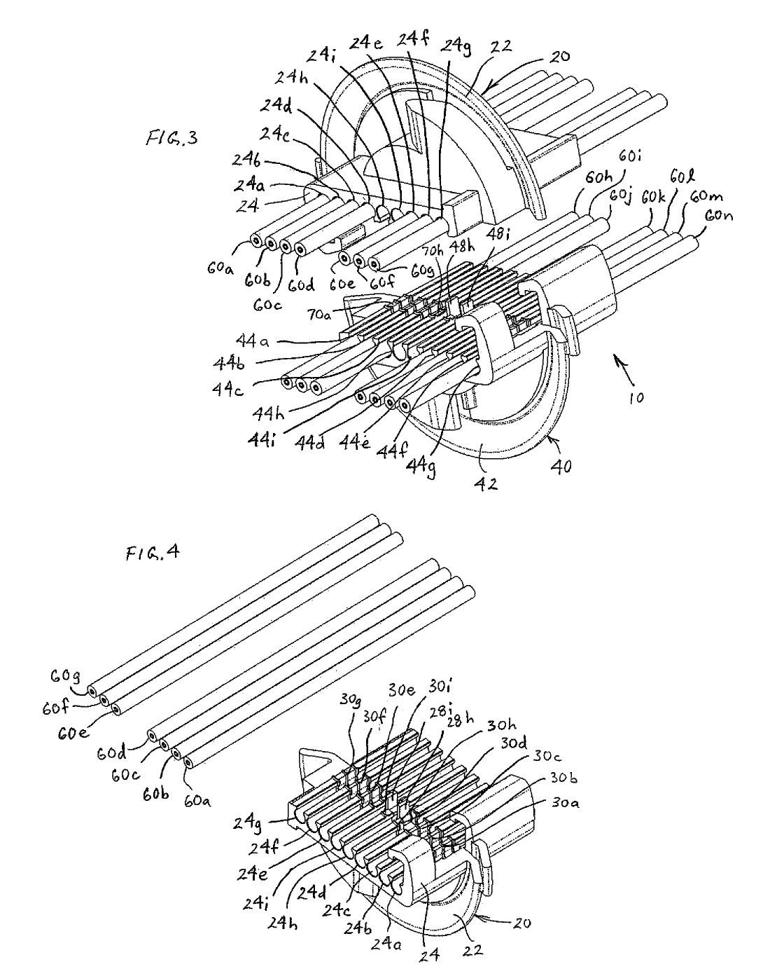

As will be appreciated in FIGS. 1-12B, for ease of manufacture, stocking, cost and assembly purposes, the grommet portions 20, 40 in this first example are preferably of an identical configuration, although such likeness of grommet portions would not be required. In FIG. 3, each grommet portion 20, 40 is shown containing several wires of the wire harness 60. Each individual wire 60a-60g is retained within its respective wire receiving groove 24a-24g, while each individual wire 60h-60n is retained within its respective wire receiving groove 44a-44g. FIG. 3 also illustrates two removable plugs 48h, 48i in wire receiving grooves 44h, 44i, while FIG. 4 illustrates two removable plugs 28h, 28i in wire receiving grooves 24h, 24i, respectively.

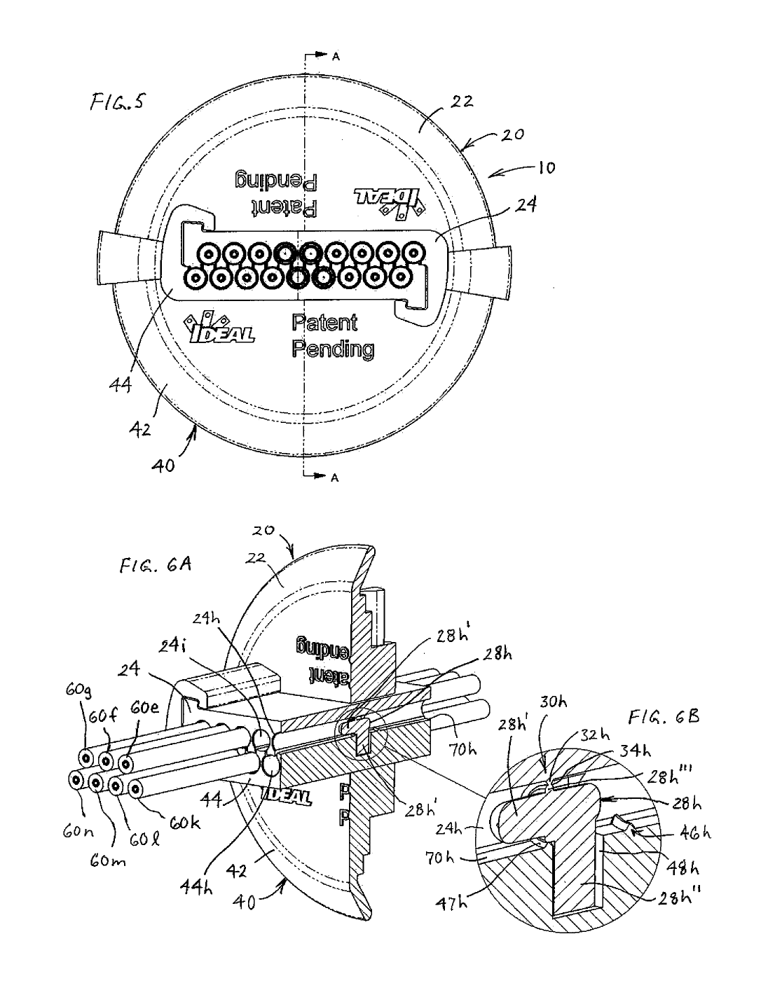

While this first example shows two wire receiving grooves with removable plugs and seven open wire receiving grooves to retain wires for each grommet portion 20, 40, it will be appreciated that only one removable plug or more than two removable plugs can be provided to accommodate various wire harness requirements, because an opposing raised partition between each pair of open wire receiving grooves must be available to interact with and seal each wire plug. Thus, the offset wire receiving grooves of one grommet portion, with respect to the opposed grommet portion, results in each wire receiving groove of one grommet portion being aligned with a partition in the opposed grommet portion. It also will be appreciated that if removable plugs are employed, the total number of wire receiving grooves can be adjusted in the same fashion, by removal of appropriate plugs. FIG. 4 also illustrates optional compressible wire seals 30a-30i that are located within each wire receiving groove 24a-24i. It will be appreciated that uses of a grommet assembly that require fluid tight sealing may employ the wire seals 30a-30i. The wire seals 30a-30i may include one or more raised ribs, and in the example shown, the wire seals 30a-30i have varying configurations in which each of the wire seals 30a-30c and 30f-30g each include three spaced-apart, raised ribs 32a-32c and 32f-32g. The raised ribs of the wire seals are generally triangular shaped, with a truncated, squared-off top, but it will be appreciated that other configurations could be used. As will be understood from the drawings and discussion below of FIGS. 6A-6B, within the wire receiving grooves 24h, 24i, the wire seals 30h, 30i include a single generally raised rib 32h, 32i, while in the wire receiving grooves 24d, 24e, which are adjacent the wire receiving grooves 24h, 24i that have the removable plugs 28h, 28i, the wire seals 30d, 30e include a pair of generally raised ribs 32d, 32e .

FIG. 6A is a perspective view of section A-A of the grommet assembly 10 with wires installed in several of the wire grooves, with the section taken from the end view shown in FIG. 5. FIG. 6A shows the location of the removable plug 28h, which is shown in more detail in FIG. 6B. In FIG. 6B, the removable plug 28h includes a body 28h′ that lies within the wire receiving groove 24h and a pull tab 28h″ that extends into a notch 48h in the second grommet portion 40. In this example, the removable plug 28h is integrally molded into and connected to wire receiving groove 24h of grommet portion 20. The removable plug 28h has a raised rib 28h′″ around the body 28h′ which is connected to a raised rib 32h in the wire receiving groove 24h by a thin web 34h. It will be appreciated that the thin web 34h is preferably approximately 0.005-0.010 inches thick so as to permit a relatively robust seal if the removable plug 28h is left in place, while still being thin enough to be torn without damaging the raised rib 28h′″ around the body 28h′ or the raised rib 32h within the wire receiving groove 24h if the removable plug 28h is torn free of the grommet portion 20 by grasping and pulling the pull tab 28h″.

In the position shown in FIGS. 6A-6B, with the grommet portions 20, 40 connected to each other, the removable plug 28h also engages a wire seal 46h at a raised rib 47h along the top surface of a partition 70h between wire receiving grooves 44h and 44i. The top surface of the partition 70h is preferably generally convex, so as to better conform to the portion of the circumference of the wire for which it is to provide a seal. When the removable plug 28h is removed, such as by tearing the thin web 34h, the plug 28h will separate from the wire receiving groove 24h, leaving behind the raised rib 32h of the compressible wire seal 30h. The raised rib 32h then is available to provide a seal around a portion of the circumference of a wire that may be installed in the wire receiving groove 24h.

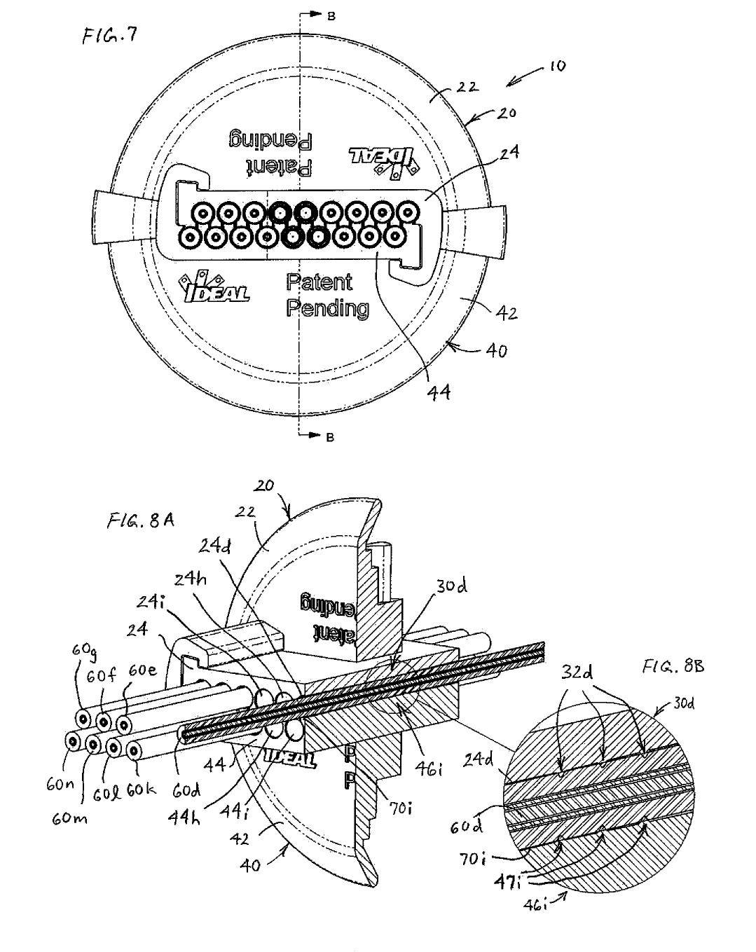

FIG. 8A is a perspective view of section B-B of the grommet assembly 10 with wires installed in several of the wire receiving grooves, with the section taken from the end view shown in FIG. 7. FIG. 8A shows a wire 60d within a wire groove 24d, with the wire 60d engaging and sealed with respect to the wire groove 24d via the compressible wire seal 30d. As shown in more detail in FIG. 8B, the wire seal 30d is comprised of three spaced-apart, raised, ribs 32d. In addition, at the segment of the circumference that is not sealed by the wire seal 30d of the first grommet portion 20, the second grommet portion 40 provides a wire seal 46i, which includes three raised ribs 47i along the top surface of the partition 70i that separates wire receiving grooves 44i and 44d.

As shown in an end view of the grommet portion 20 in FIG. 9, the wire receiving grooves 24a-24i generally comprise two features, namely a cylindrical slot 36a-36i and a pair of partitions 80a-80i, respectively, that form the sides of the cylindrical slot. Thus, for example, wire receiving groove 24b includes a cylindrical slot 36b and respective partitions 80a, 80b. The top surface of the partitions 80a-80i preferably are generally convex, so as to better conform to the portion of the circumference of the wires for which they are to provide a seal. As is best seen in FIGS. 3 and 4, the raised ribs 32a-32i of the respective wire seals 30a-30i run along the arcuate surface of the wire receiving grooves 24a-24i, as well as over the top surface of the partitions 80a-80i. It will be appreciated that the same construction is present with second grommet portion 40 where partitions 70a-70i separate wire receiving grooves and include raised ribs of wire seals.

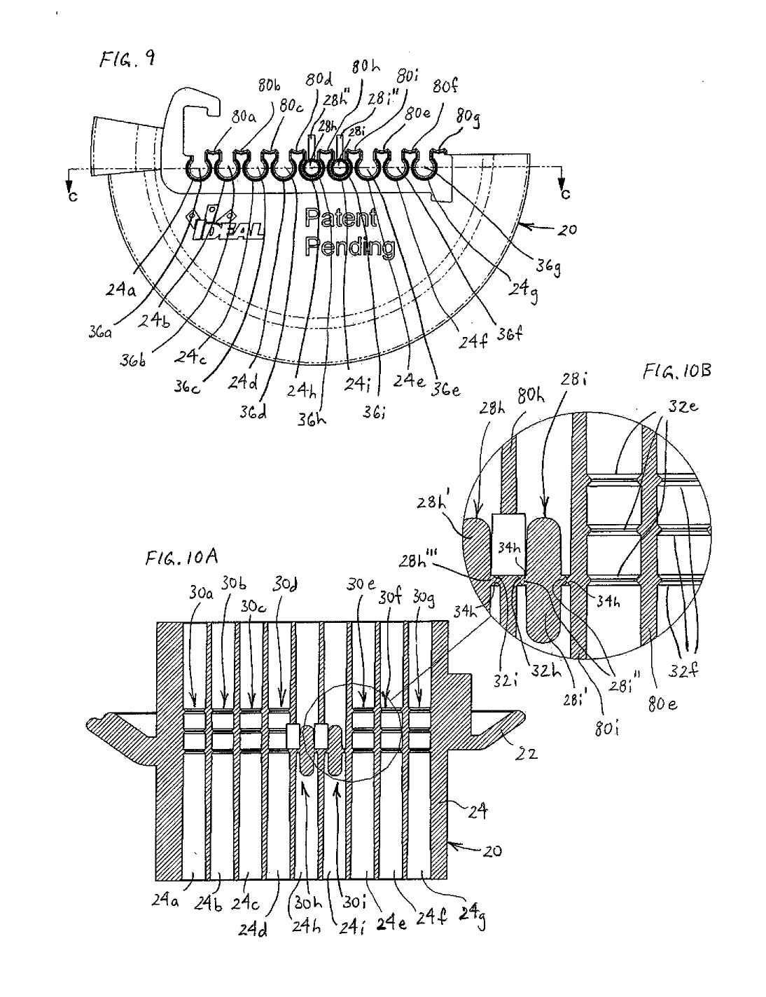

FIG. 10A shows a section C-C of the grommet portion 20 from the end view shown in FIG. 9. This view illustrates the compressible wire seal 30a-30g for each wire receiving groove 24a-24g with the exception of the two wire receiving grooves 24h, 24i. While it would be preferred to have the triple seal in all of the wire receiving grooves 24a-24h, the integral molding of the removable plugs 28h, 28i into the wire grooves 24h, 24i, respectively, prohibits the formation of the triple seal design, due to the creation of undercuts by the compressible wire seal section. If the removable plugs 28a, 28b were molded separately and then assembled into the wire receiving grooves 24h, 24i, then it would be possible to have the wire seals 30h, 30i be both compressible triple wire seals and have a removable plug in the same wire receiving groove. In this example, the removable plugs are integrally molded into the wire receiving grooves, which eliminates the need for extra assembly operations and leaves the thin webs 34h, 34i to provide a seal that is connected over a significant portion of the circumference of the removable plug.

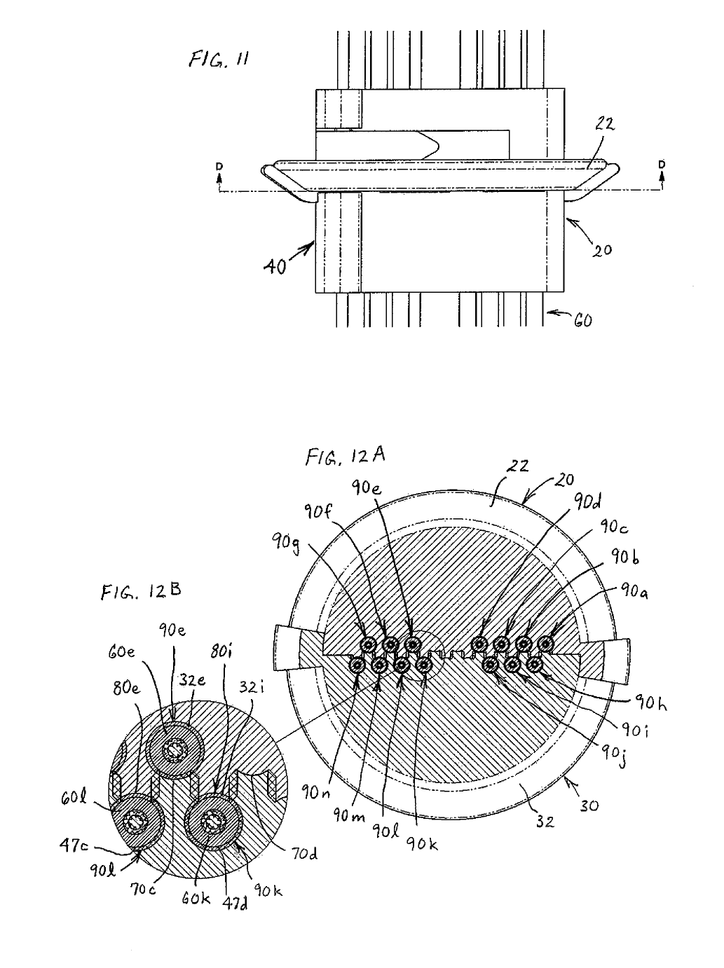

FIG. 12A is a section D-D taken from the top view of the grommet assembly 10 in FIG. 11. This section view illustrates the compressible wire seal as it compresses around the circumference of the wires. The wires 60a-60n are held individually in each respective wire receiving groove 24a-24g, 44a-44g, as seen in FIG. 3, because as noted above, the wire receiving grooves are formed with cylindrical slots that engage more than 180 degrees of the circumference of the wires. This permits each grommet portion 20, 40 to retain wires during assembly of the grommet portions to a wire harness and to each other. As seen in FIG. 12B, the generally convex top surfaces of the partitions 70a-70i with their raised ribs 47a-47i (for example as seen in FIG. 8B) engage the top edges of the openings created by the cylindrical slots 36a-36i (seen in FIG. 9) in the opposing first grommet portion 20, while the convex raised ribs 32a-32i (seen for example as 32e and 32f in FIG. 10B) engage the top edges of the openings created by the cylindrical slots 49a-49i formed in the respective wire receiving grooves 44a-44g on the opposing second grommet portion 40. Thus, it will be appreciated that when the first and second grommet portions 20, 40 are assembled together to form the grommet assembly 10, the offset configuration of the respective cylindrical slots of the wire receiving grooves of the opposed grommet portions cause the raised ribs of the opposing cylindrical slots and partition ribs to form a complete seal around each wire. Due to this combination of raised ribs that cover the entire circumference of each wire, as shown in FIG. 12B, the compressible wire seals create respective compression zones 90a-90n around each wire 60a-60n, as seen in FIGS. 12A and 12B. The height and compressibility of the raised ribs additionally allows for sealing of wires having different diameters within the same grommet assembly.

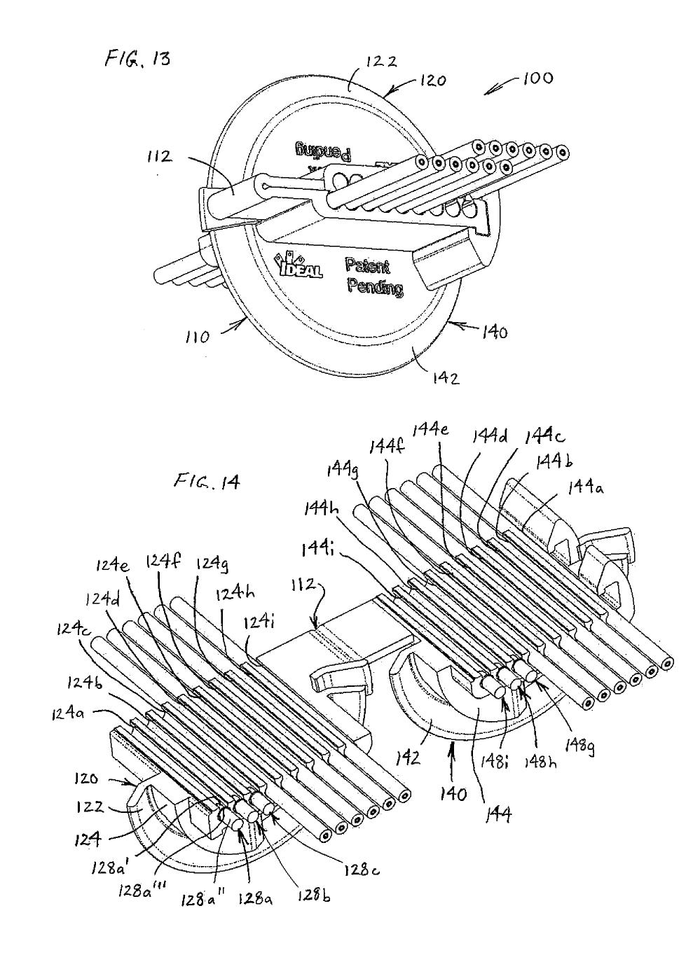

FIGS. 13 and 14 illustrate a second example grommet assembly 100. In the grommet assembly 100, a first grommet portion 120 and second grommet portion 140 are formed as a single piece 110, with the first and second grommet portions 120, 140 being connected by an integrally molded living hinge 112. The structures for sealing to a panel are similar to those described above for the first example grommet assembly 10 and include semi-panel seals 122, 142. The structures for retaining the wires for this second example grommet assembly 100 also are similar to those described above with respect to the first example grommet assembly 10. For instance, first grommet portion 120 includes a wire pass thru section 124 having associated wire receiving grooves 124a-124i, while the second grommet portion 140 includes a wire pass through section 144 having associated wire receiving grooves 144a-144i. It will be appreciated that the second example grommet assembly 100 does not include wire seals for the wire receiving grooves and partitions therebetween, however such structures, as described above with respect to the first embodiment, could be included with the respective wire seals having at least one raised rib to form a compression zone around a wire when the first and second grommet portions 120, 140 are hinged to a closed position and the cylindrical slots cooperate with the top of the opposed partitions.

Aside from the hinged connection, the second example grommet assembly 100 does differ in a further way relative to the first example. Rather than optionally having at least one removable plug located at the center along the length of a wire receiving groove, as shown in FIG. 14, optional removable plugs 128a-128c, 148g-148i are each located at one end of the respective wire receiving grooves 124a-124c, 144g-144i. The removable plugs 128a-128c, 144g-144i each may be connected within the respective wire receiving grooves in the same manner as described above with respect to the connection of a removable plug via a thin web that can be torn to affect removal of the respective removable plug. In this example, an optional removable plug, for example 128a, includes a body 128a′ located within the respective wire receiving groove 124a and includes a portion that extends out from the end of the wire receiving groove 124a, forming a pull tab 128a″. Also, a raised rib 128a′″ extends around the body 128a′ and is connected to the thin web within the wire receiving groove 124a while presenting a sealing element within the open span at the top of the cylindrical slot for engagement with the top of an opposed partition on the second grommet portion 140.

As with the prior example, while the example grommet assemblies 10, 100 have been shown with a plurality of wire receiving grooves and a plurality of removable plugs that allow for expansion of the number of wires that may be installed, it will be appreciated that a grommet assembly may be constructed with at least one wire receiving groove and optionally may include at least one removable plug. Thus, consistent with this disclosure, a grommet assembly may be constructed with one or more wire receiving grooves, and the wire receiving grooves may not include any removable plugs or may include one or more removable plugs. Accordingly, grommet assemblies may be custom made for particular applications in which no removable plugs are included, or they may be made with one or more removable plug to permit more options for the number of wires that will be accommodated.

Although the present disclosure describes particular example embodiments, it is to be understood that the disclosure is not to be interpreted as limiting the appended claims. Various alterations and modifications will no doubt become apparent to those skilled in the art after having read the above disclosure. Accordingly, it is intended that the appended claims be interpreted as covering all alterations and modifications that fall within the true spirit and scope of the invention.

I claim:

1. A grommet assembly having first and second grommet portions, with each grommet portion having at least one wire receiving groove, with the at least one wire receiving groove of the first grommet portion comprising a cylindrical-shaped slot adapted to receive and engage more than 180 degrees of the circumference of a first wire and the at least one wire receiving groove of the second grommet portion comprising a cylindrical-shaped slot adapted to receive and engage more than 180 degrees of the circumference of a second wire.

2. The grommet assembly of claim 1, wherein the first and second grommet portions are identical.

3. The grommet assembly of claim 1, wherein the first and second grommet portions are connected by a hinge. .

4. The grommet assembly of claim 3, wherein the hinge is a living hinge.

5. The grommet assembly of claim 1, wherein each wire receiving groove comprises a compressible wire seal.

6. The grommet assembly of claim 5, wherein each wire seal comprises at least one raised rib.

7. The grommet assembly of claim 6, wherein each raised rib comprises a generally triangular section.

8. The grommet assembly of claim 7, wherein each generally triangular section of each raised rib has a truncated, squared-off top.

9. The grommet assembly of claim 1, wherein at least one wire receiving groove contains at least one removable plug.

10. The grommet assembly of claim 9, wherein the at least one removable plug is integrally molded as part of the first grommet portion.

11. The grommet assembly of claim 9, wherein the at least one removable plug is centered along the at least one wire receiving groove.

12. The grommet assembly of claim 9, wherein the at least one removable plug is located proximate one end of the at least one wire receiving groove.

13. The grommet assembly of claim 9, wherein the at least one removable plug further comprises a pull tab for grasping when removing the removable plug.

14. The grommet assembly of claim 9, wherein the at least one removable plug is connected to the at least one wire receiving groove by a thin web.

15. The grommet assembly of claim 1, wherein the at least one wire receiving groove of the first grommet portion is offset with respect to the at least one wire receiving groove of the second grommet portion.

16. The grommet assembly of claim 15, wherein each of the first and second grommet portions further comprises a partition between at least two respective wire receiving grooves.

17. The grommet assembly of claim 16, wherein at least one partition of the first grommet portion is aligned with at least one wire receiving groove of the second grommet portion.
